(19) United States
(12) Patent Application Publication
(10) Pub. No.: US 2008/0133344 A1
(43) Pub. Date: Jun. 5, 2008

(54) SYSTEMS AND METHODS FOR PROVIDING CROSS-VERTICAL ADVERTISEMENT

(75) Inventors: ADAM HYDER, LOS ALTOS, CA (US); CHANGSHENG CHEN, HAYWARD, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., SUNNYVALE, CA (US)

(21) Appl. No.: 11/567,176

(22) Filed: Dec. 5, 2006

(51) Int. Cl. G06Q 30/00

(52) U.S. Cl. 705/14

(57) ABSTRACT

Methods and systems of providing advertisements for multiple verticals are disclosed herein. A first vertical weight for a first vertical is calculated according to user activity patterns of a user in the first vertical. A second vertical weight for a second vertical is calculated according to user activity patterns of the user in the second vertical. At least one first vertical advertisement is received from a first vertical advertisement engine. At least one second vertical advertisement is received from a second vertical advertisement engine. A first score is calculated for the at least one first vertical advertisement using the first vertical weight. A second score is calculated for the at least one second vertical advertisement using the second vertical weight. The at least one first vertical advertisement is provided to the user if the first score is higher than the second score. The at least one second vertical advertisement is provided to the user if the second score is higher than the first score.

### BACKGROUND

1. Field

The present disclosure relates to Internet verticals. In particular, it relates to systems and methods of providing targeted advertisement according to one or more Internet verticals.

2. General Background

Internet advertising has become a prime direct marketing channel for companies selling goods and services. Furthermore, Internet advertising offers the unprecedented opportunity to tailor individualized ads to online users because online users generate behavioral and demographic data that provide insight into their goals and preferences. User behavior can be established by tracking user activities online, storing user preferences, etc. In addition, activities for a specific service or vertical can be tracked differently than activities tracked for another service or vertical. Internet verticals generally refer to specialized services such as job listings and recruiting, automobile commerce, real estate, personal dating services, etc. At any point in time a user can have higher interest in one service or vertical over another.

### SUMMARY

In one aspect, there is a method of providing advertisements for multiple verticals are disclosed herein. A first vertical weight for a first vertical is calculated according to user activity patterns of a user in the first vertical. A second vertical weight for a second vertical is calculated according to user activity patterns of the user in the second vertical. At least one first vertical advertisement is received from a first vertical advertisement engine. At least one second vertical advertisement is received from a second vertical advertisement engine. A first score is calculated for the at least one first vertical advertisement using the first vertical weight. A second score is calculated for the at least one second vertical advertisement using the second vertical weight. The at least one first vertical advertisement is provided to the user if the first score is higher than the second score. The at least one second vertical advertisement is provided to the user if the second score is higher than the first score.

In one aspect, the user activity patterns of the user in the first vertical include searching the first vertical and/or selecting an item listed in the first vertical. In a further aspect, the user activity patterns of the user in the second vertical include searching the second vertical, and/or selecting an item listed in the second vertical.

In a further aspect, a first associated rating for the at least one first vertical advertisement is received. A second associated rating for the at least one second vertical advertisement can also be received. The first score is calculated by multiplying the first vertical weight by the first associated rating. The second score can be calculated by multiplying the second vertical weight by the second associated rating.

In another aspect, a third vertical weight for a third vertical can be calculated according to user activity patterns of the user in the third vertical. At least one third vertical advertisement is received from a third vertical advertisement engine. A third score for the at least one third vertical advertisement can be calculated using the third vertical weight. The at least one third vertical advertisement can be provided to the user if the third score is higher than the first score and the second score.

In yet another aspect, the first vertical and/or the second vertical is an Internet job listing service, an Internet dating service, an Internet media delivery service, or an Internet media upload service.

In one aspect, there is a system that provides advertisements from multiple verticals comprising and a recommendation chooser and a user interface module. The recommendation chooser engine can calculate a first vertical weight for a first vertical according to user activity patterns of a user in the first vertical. The recommendation chooser engine can calculate a second vertical weight for a second vertical according to user activity patterns of the user in the second vertical. The recommendation chooser engine further configured to calculate a first score for at least one first vertical advertisement using the first vertical weight. The recommendation chooser engine can further be configured to calculate a second score for at least one second vertical advertisement using the second vertical weight. The user interface module provides the at least one first vertical advertisement to the user if the first score is higher than the second score. The user interface module can be configured to provide the at least one second vertical advertisement to the user if the second score is higher than the first score.

In a further aspect, there is a method of providing advertisements from multiple verticals. A first vertical weight for a first vertical is calculated according to user activity patterns of a user in the first vertical. A second vertical weight for a second vertical is calculated according to user activity patterns of the user in the second vertical. A relevant vertical is identified. The relevant vertical is the first vertical if the first vertical weight is greater than the second vertical weight. The relevant vertical is the second vertical if the second vertical weight is greater than the first vertical weight. At least one advertisement can be requested from a vertical advertisement engine corresponding to the relevant vertical. The at least one advertisement can be provided to the user.

### DRAWINGS

The features and objects of alternate embodiments of the present disclosure will become more apparent with reference to the following description taken in conjunction with the accompanying drawings of various examples wherein like reference numerals denote like elements and in which:

FIG. 1 depicts a component diagram of a system for providing advertisements from multiple verticals according to one embodiment.

FIG. 2 depicts a component diagram of an exemplary network server according to one embodiment.

FIG. 3 depicts a component diagram of a computing device according to one embodiment.

FIG. 4 depicts a flow diagram of a process for selecting advertisements relevant to the user according to one embodiment.

FIGS. 5A and 5B depict exemplary tables of advertisement rankings and vertical weights for multiple verticals according to another embodiment.

FIG. 6 depicts an exemplary table of advertisement scores according to another embodiment.

FIG. 7 depicts a flow diagram of a process for selecting advertisements relevant to the user according to another embodiment.

### DETAILED DESCRIPTION

Various methods and systems for advertisement delivery are disclosed. A service provider can host one or more verticals. The service provider hosts a recommendation engine for each vertical. The recommendation chooser engine can have access to all user data, preferences, profiling, history (e.g., web pages visited), and behavior in order to make reasonable recommendations for users. When a user visits a web page hosted by the service provider, the recommendation chooser provides the most relevant ad to be presented to the user. Relevant ads are presented to users based on user preference of, or high frequency of access to, one or more verticals. Thus, the user is presented with ads that are relevant to the verticals that the user visits often during the online experience of the user, even when the user is not in the verticals preference by the user. In addition, the advertisements are provided by each vertical therefore having best tailored to the user. The recommendation chooser is therefore configured to choose among advertisements of various verticals and present those advertisements that are most relevant to the user. In one approach, the recommendation chooser can query each the recommendation engine of each vertical to get the recommended ads from each vertical. Using pre-determined user preference for verticals, the recommendation chooser can decide what the best advertisement to present to the user is.

As discussed herein, a vertical is a specialized process or service that provides users a specialized experience within a larger universe of services. For example, within a service provider such as Yahoo!, a vertical can include Calendar, Classifieds, Education, Entertainment, Finance, Food, Games, Health, Horoscopes, Jobs, Kids, Maps, Messenger, Movies, Music, Personals, Photos, Real Estate, Shopping, etc.

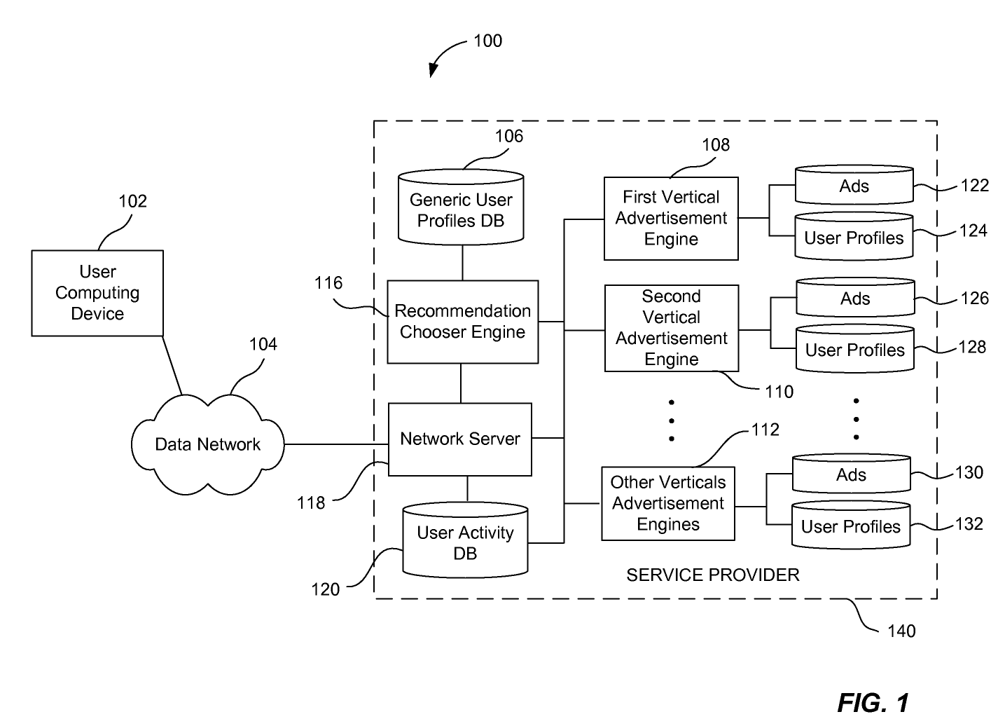

FIG. 1 depicts a component diagram of a system for providing advertisements from multiple verticals according to one embodiment. In one embodiment, the service provider 140 can host one or more online services or verticals. As such the service provider 140 can be a business entity that owns and operates a computer infrastructure connected to a data network 104 in order to provide a plurality of verticals that can be accessed by users. Users can access the verticals provided by the service provider 140 via a data network 104. In one embodiment, the data network 104 is the Internet. In another embodiment, the data network 104 is an intranet. A user can utilize a user computing device 102 to communicate via the data network 104 with one or more computing modules and or services that are part of the computer infrastructure managed by the service provider 140.

In one embodiment, the computer device 102 can be configured with a web browser that allows the user computing device 102 to send data to and receive data from a network server 118. The computing device 102 communicates with the network server to render web pages received from the network server 118, as well as transmit user input to the network server 118. In another embodiment, the user computing device 102 can communicate through the data network 104 via any client-side application configured to communicate in a predetermined protocol with the network server 118.

In one embodiment, the network server 118 is configured as a portal to multiple verticals provided by the service provider 140. As such, the network server can provide multi-vertical access to a user. For example, the user may access Automobiles vertical where the user can request information about automobiles, post for sale vehicles and parts, view listings, etc. In this example, the network server 118 can communicate with processes, modules, and any other computer infrastructure that can provide with the capability of interacting with the user, and providing the user with information regarding automobiles. Likewise, the network server can also allow for alternative verticals to be explored by the user. For example, the user can request information regarding dating services or job listing services, etc. As one skilled in the art will understand, the network server can be a plurality of servers, each of which can be a server that is dedicated for a specific vertical.

As the user interacts with the service provider 140, the network server 118 can also be configured to track user activity and record such user activity in multiple data repositories. For example, the network server 118 can record user activity such as web requests, search queries, search results, listings saved, printed, e-mailed, listings used, bid, bought, applied for, viewed, discarded, requested media, uploaded media, etc. User activity can be stored in a user activity database 120, which stores data that related to user behavior that is generic for all verticals, as well as data that is specific to the vertical. Generic and vertical-specific information can be accessed and utilized by modules or processes associated with each vertical depending on the use required by each vertical.

In addition to implicit data collected from user behavior online, the network server 118 can also collect explicit data provided by the user. For example, the network server 118 can record user demographic information entered by the user, such as age, gender, name, date of birth, etc., at a generic user profiles database 106. The generic user profiles database 106 can also include data that is generic for the user and applicable to any vertical in which the user might be interacting.

In addition, each vertical can also be configured with processes or modules that can store user demographic or other user specific data for each vertical at user profiles for each specific vertical. For example, user profiles 124, 128, and 132 can be utilized to store vertical-specific user information that can later be retrieved by vertical search engines, and other vertical engines.

In a further embodiment, the network server 118 can communicate with a recommendation chooser engine 116 in order to receive advertisement information relevant to the user. As such, the recommendation chooser engine 116 can interact with one or more vertical advertisement engines and determine which ads corresponding to which vertical should be presented to a user. The recommendation chooser engine 116 can use one or more algorithms to perform the selection of the most relevant ads that are to be presented to the user.

In one embodiment, the recommendation chooser engine 116 establishes a user-specific weight to be assigned to each of the verticals with which a user has interacted. The recommendation user engine 116 can make such determination by searching the user activity database and identify the frequency with which a user accesses each vertical. In addition, the recommendation chooser engine can also access the generic user profile's database 116 to view any additional information that can allow the recommendation chooser engine 116 to determine the user's frequency of access to each vertical. In a further embodiment, the recommendation chooser engine 116 could also access the user profiles databases for each vertical, namely, user profiles database 124, user profiles database 128, and user profiles database 132. Accordingly, based on all of the information gathered about user behavior, implicit or explicit, the recommendation chooser engine 116 can establish a weight for each of the verticals as applied to a specific user.

For example, utilizing the user's recent history of online activity, the recommendation chooser engine 116 can calculate that the user is recently mostly interested in finding a job, somewhat interested in purchasing a computer laptop, and also interested in romance. Thus, based on the user's history and behavior, the recommendation chooser engine 116 can assign a weight of 0.5 to a job's vertical, a weight of 0.3 to a shopping vertical, and a weight of 0.2 to a dating service. Thus, based on the weights for each of the verticals, the recommendation chooser engine 116 can request one or more advertisement items to be submitted or transmitted by vertical advertisement engines on each of the verticals.

For example, the recommendation chooser engine 116 can make a request to the first vertical advertisement engine 108 to provide one or more advertisements to be presented to the user. The first vertical advertisement engine 108 can in turn select from an ads database 122, one or more advertisements that can be presented to the user, based on user preferences and history retrieved from the user profile's database 124. For instance, if the first vertical is a job's vertical, the first vertical advertisement engine 108 can query the user profile 124 to select the user profile for the job hunting activities of the user, and further, select a relevant ad or ads from the database 122. In addition, the first vertical advertisement engine 108 can also be configured to rank the ads selected from the ads database 122, such that more relevant ads can have a higher ranking than less relevant ads in the first vertical. The first vertical advertisement engine 108 can make the determination of ad relevancy based on user-specific behavior. In one example, the relevancy can be based on verticals sub-categories in which the user may be interested. Thus, if the user has interacted with a shopping vertical, a sub-category of the shopping vertical can be clothing or electronics. Thus, a user that has demonstrated through his behavior to interested in electronics, ads for electronics would have a higher relevancy than ads for a clothing subcategory. In another example, ad relevancy can also be based on recency of user interaction. Thus, if the user has recently purchased various items of clothing, the relevancy of clothing may be high because of the recency of interest. In addition, timing can also be taken into account in order to determine relevancy. If the user profile demonstrates that the user has historically been interested in electronics during the holidays season, then advertisements for electronics can be given higher relevancy than clothing advertisements.

In addition, the recommendation chooser engine 116 can also request the second vertical advertisement engine 110 to provide one or more ads that are relevant in the second vertical. Thus, for example, if the second vertical is a vertical for shopping, the second vertical advertisement engine 110 can select the shopping profile of the user from the user profile database 128 and further select relevant advertisements from the ads database 126 to be presented to the user.

As such, the second vertical advertisement engine 110 would provide shopping advertisements to the recommendation chooser engine 116. As illustrated in FIG. 1, the number of verticals is unlimited. In other words, a plurality of verticals and associated infrastructure can be utilized by a service provider 140 such that the number of verticals is scalable to fit any number of services that can be provided to a user. The second vertical advertisement engine 110 can also make the determination of ad relevancy based on user-specific behavior such as time, user interest in a subcategory, etc.

Therefore, other vertical advertisement engines 112 can also be communicated with the recommendation chooser engine 116 and provide relevant advertisements specific to each of the verticals. As such, each of the other verticals can also have advertisement databases 130, and user profiles databases 132 for each of the additional verticals. The other vertical advertisement engines 112 can also make the determination of ad relevancy based on user-specific behavior such as time, user interest in a subcategory, etc.

Once the recommendation chooser engine 116 receives from all the verticals advertisement engines a list of one or more advertisements, the recommendation chooser engine 116 can use the predefined weights for each of the verticals to select the advertisements to be presented to the user. As exemplified below, the recommendation chooser engine 116 can present the advertisements based on a score determined by multiplying the ranking of the advertisement times the weight of the vertical corresponding to the advertisement.

In a further embodiment, the recommendation chooser engine 116 can further score the advertisements received from each of the vertical advertisement engines and take into account a time factor. For example, based on user profile data, the recommendation chooser engine 116 can determine that the user has historically liked to search for jobs during weekdays morning. In addition, the recommendation chooser engine 116 can also determine that the user has historically liked to interact with a dating vertical on weekday nights. Thus, the recommendation chooser engine 116 can be configured to rate advertisements received from vertical advertisement engines according to one or more scoring algorithms. In the previous example, advertisements for job listings can have a higher score during weekday mornings, while advertisements for dating services can have a higher score during weekday nights.

In yet another embodiment, recommendation chooser engine 116 can further score the advertisements received from each of the vertical advertisement engines and take into account a pre-established time factor. For example, regardless of user preferences or historical data, the recommendation chooser engine 116 can be configured to provide advertisements for shopping verticals with a higher score during the holiday season than during off-season.

Once all of the advertisements for all of the verticals are scored, the advertisements with highest scores can be presented to the user. As such, if the network server 118 requests two advertisements from the recommendation chooser engine 116, the recommendation chooser engine 116 can provide the two advertisements with the highest scores. In yet another embodiment, the recommendation chooser engine 116 can select the vertical having the highest weight, and request the vertical advertisement engine corresponding to such vertical with the highest weight to provide one or more advertisements for presentation to the user. In yet another embodiment, the recommendation chooser engine 116 can select the two verticals having the highest weight, and request the vertical advertisement engine corresponding to each such vertical to provide one or more advertisements for presentation to the user.

While various databases have described herein, one skilled in the art will recognize that each of the aforementioned databases can be combined into one or more data repositories, and be located either locally or remotely. In addition, each of the aforementioned databases can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

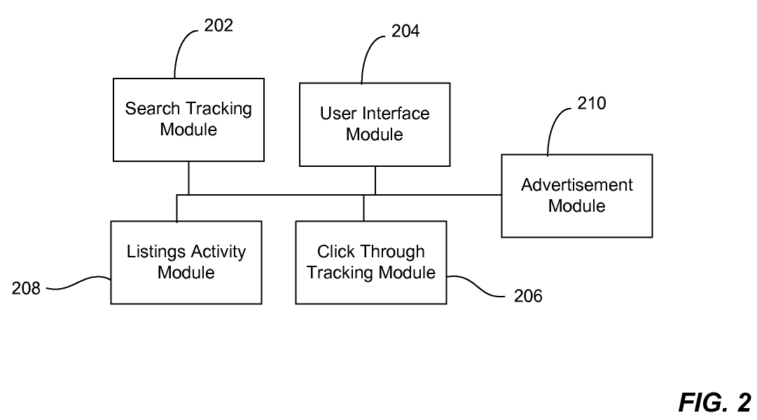

FIG. 2 depicts a component diagram of an exemplary network server according to one embodiment. As mentioned previously, the network server 118 can include one or more processing modules that allow the network server 118 to interface via the data network 104 with a user computing device 102, as well as collect useful information and request advertisement information. As such, the network server 118 can be configured with a search tracking module 202 that allows recording search data. For example, the search tracking module 122 can store search criteria such as category of the search criteria, location, terms and keywords. In addition, the search tracking module 202 can also track search results such as actual text and hyperlinks in the results page, etc. In another embodiment, a listings activity module 208 can also be configured as part of the network server 118. For example, the listings activities module 208 can record listings posted by a user such as selling a car or a personal ad. In addition, the listings activity module 208 can also record user activity regarding visited listings such as saved listings, printed listings, emailed listings, viewed or purchased listings, etc. Also, other listings that can also be recorded can be listings that have been used, such as bid listings, bought listings, applied for listings, viewed and not used listings, etc.

In yet another embodiment, the network server 118 can also include a click through tracking module 206. The click through tracking module 206 can be configured to store the click through rate of ads as they relate to a specific user. In a further embodiment, the click through tracking module 206 can also store the links and/or ads that a user had previously selected in connection with a specific vertical.

The network server 118 can also include a user interface module 204 that permits the network server 118 to communicate with a computing device 102. For example, the user interface module 204 can be a web server. As it is known in the art, a web server can be configured to submit Internet pages to be rendered at a web browser on the user computing device 102. In addition, a web server can also be configured to receive web page requests and transmit to the user computing device 102 requested web pages, images, text, and any other data or media requested by the user computing device 102.

In yet another embodiment, the network server 118 can also be configured with an advertisement module 210 that allows a network server to request advertisements from the recommendation chooser engine 116. Also, the advertisement module 210 can interact with the user interface module 204 to present the advertisements to the user computing device 102 according to the vertical being selected by the user computing device 102, as well as preferences, history data, and online behavior in general of the user.

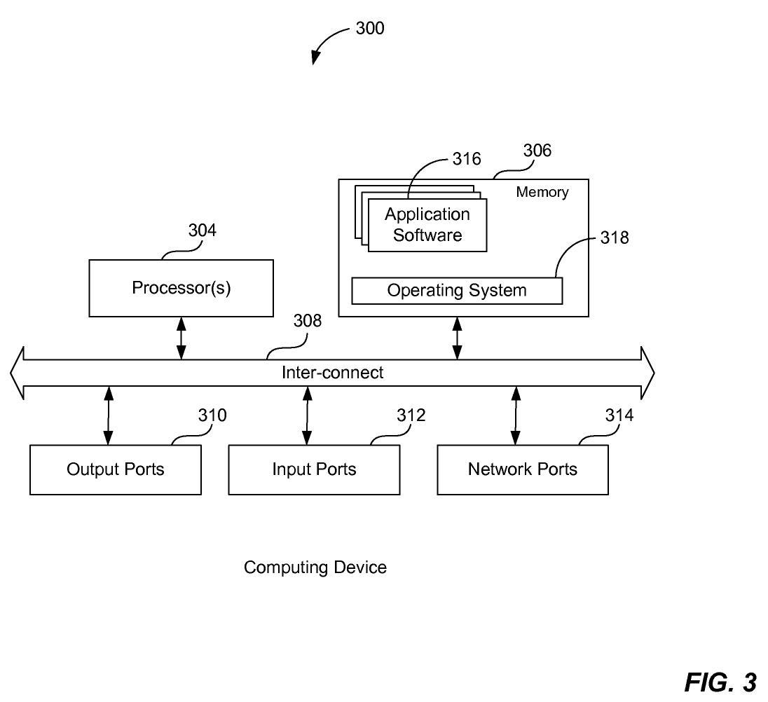

FIG. 3 depicts a component diagram of a computing device according to one embodiment. The computing device 300 can be utilized to implement one or more computing devices, computer processes, or software modules described herein. In one example, the computing device 300 can be utilized to process calculations, execute instructions, receive and transmit digital signals, as required by the user computing device 102. The computing device 300 can be utilized to process calculations, execute instructions, receive and transmit digital signals and/or data as required by the recommendation chooser engine 116, the network server 118, and the vertical advertisement engines 108,110, and 112.

The computing device 300 can be any general or special purpose computer now known or to become known capable of performing the steps and/or performing the functions described herein, either in software, hardware, firmware, or a combination thereof.

The computing device 300 includes an inter-connect 308 (e.g., bus and system core logic), which interconnects a microprocessor(s) 304 and memory 306. The inter-connect 308 interconnects the microprocessor(s) 304 and the memory 306 together. Furthermore, the interconnect 308 interconnects the microprocessor 304 and the memory 306 to peripheral devices such input ports 312 and output ports 310. Input ports 312 and output ports 310 can communicate with I/O devices such as mice, keyboards, modems, network interfaces, printers, scanners, video cameras and other devices. In addition, the output port 310 can further communicate with the display 104.

Furthermore, the interconnect 308 may include one or more buses connected to one another through various bridges, controllers and/or adapters. In one embodiment, input ports 312 and output ports 310 can include a USB (Universal Serial Bus) adapter for controlling USB peripherals, and/or an IEEE-1394 bus adapter for controlling IEEE-1394 peripherals. The inter-connect 308 can also include a network connection 314.

The memory 306 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 306 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 306 or obtained through input ports 312 and output ports 310.

In general, routines executed to implement one or more embodiments may be implemented as part of an operating system 318 or a specific application, component, program, object, module or sequence of instructions referred to as application software 316. The application software 316 typically can comprises one or more instruction sets that can be executed by the microprocessor 304 to perform operations necessary to execute elements involving the various aspects of the methods and systems as described herein. For example, the application software 316 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

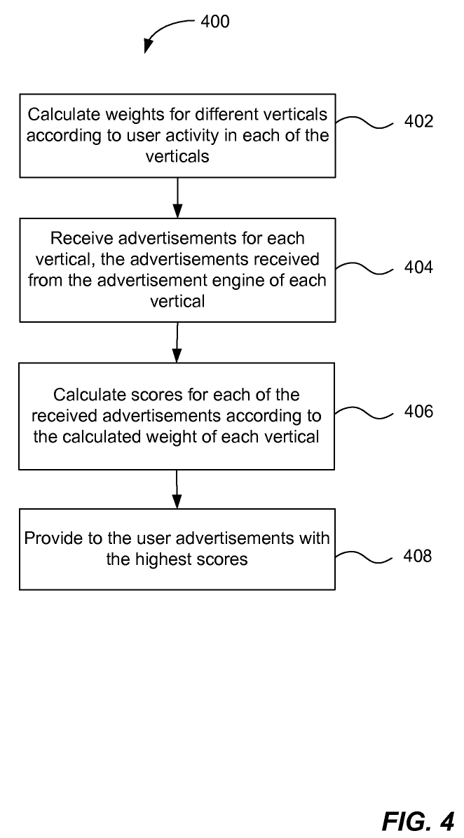

FIG. 4 depicts a flow diagram of a process for selecting advertisements relevant to the user according to one embodiment. Diagram of a process for selecting advertisements relevant to the user according to one embodiment. At process block 402, the weights for different verticals are calculated according to user activity in each of the verticals. As previously mentioned, the weights for each of the different verticals can be calculated by the recommendation chooser engine 116. Process 400 continues at process block 404.

At process block 404, advertisements for each vertical are received from the vertical advertisement engine corresponding to each of the verticals. For example, advertisements for the dating service vertical would comprise advertisements regarding dating, greeting cards, recommended romantic restaurants, ideas for a date, etc. In another example, advertisements for a real estate vertical can include listings of real estate such as houses, apartments, condos, parcels of land, real estate agents, brokerage firms, etc. As mentioned earlier, each vertical advertisement engine can make the determination of ad relevancy based on user-specific behavior such as sub-categories within verticals, time of day, recency of interaction, etc. Process 400 continues a process block 406.

At process block 406, scores for each of the received advertisements are calculated according to the weight of each vertical. In one embodiment, the scores can be calculated based on the vertical weight as well as individual advertisement rankings within each vertical. As previously discussed, the recommendation chooser engine 116 can further score the advertisements received from each of the vertical advertisement engines based on a time factor. Process 400 continues at process block 408. At process block 408, the user is provided with advertisements having the highest scores.

In one embodiment, the network server 118 may request one advertisement from recommendation chooser engine 116. The recommendation chooser engine 116 can provide the advertisement with the highest score out of all the advertisements to the network server 118, which is then presented to the user. In another embodiment, the network server 118 may request multiple advertisements from the recommendation chooser engine 116. Thus, for example, the network server 118 can request three advertisements for displaying to the user. The recommendation chooser engine 116 can choose the three advertisements with the highest scores to be presented to the user. Therefore, any number of advertisements can be presented to the user as requested by the network server 118.

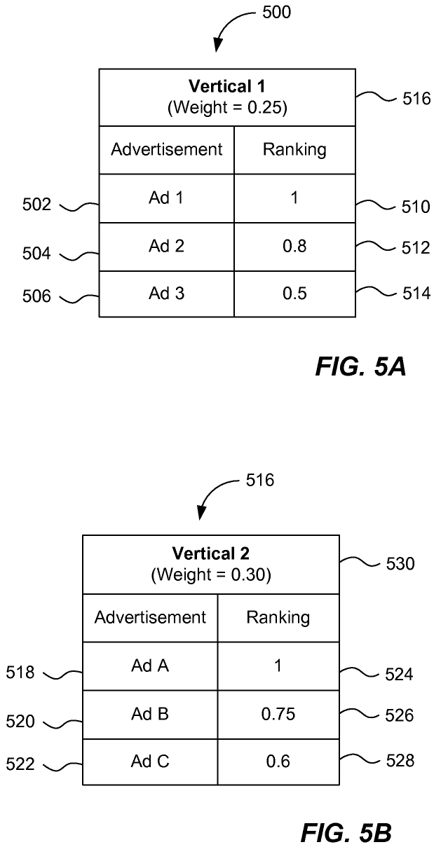

FIG. 5A depicts an exemplary table 500 of advertisement rankings and vertical weights for a first vertical according to one embodiment. In one example, the first vertical can have a weight of 0.25. In addition, the first vertical advertisement engine 108 can provide three advertisements, namely advertisements 502, 504, and 506. Advertisement 502 can be ranked with a ranking 510 of 1. Advertisement 504, corresponding to Ad 2, can be ranked with a ranking 512 of 0.8. Finally, advertising 506, corresponding to Ad 3, can be ranked with a ranking 514 of 0.5. The rankings within each vertical can be reflective of the relevance of each of the advertisements 502, 504, and 506 as related to the user. In one embodiment, the ranking, the weights, and the scores can be numbers that fall within the range of the 0 to 1. As such, for example, the ranking of the first advertisement 502 has the highest ranking, meaning a ranking of 1.

FIG. 5B depicts an exemplary table of advertisement rankings and vertical weight for a second vertical, according to another embodiment. Table 516 illustrates a weight 530 of a second vertical. The weight 530 can be, for example, 0.3. In addition, advertisements provided by a second vertical advertisement engine 110 corresponding to the second vertical can be ranked according to relevancy to a user. For example, advertisement 518, namely Ad A, can be ranked with a ranking 524 of 1. In addition, advertisement 520, namely Ad B, can be ranked with ranking 526, namely 0.75. Advertisement 522, namely Ad C, can be ranked with ranking 528, namely 0.6.

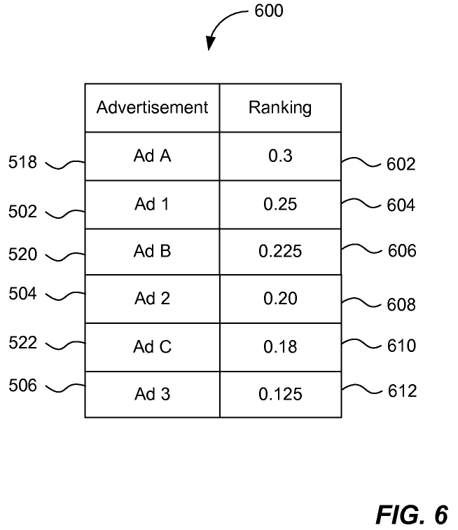

FIG. 6 depicts an exemplary table 600 of advertisement scores according to another embodiment. Table 600 illustrates score of each of the advertisements received from multiple vertical advertisement engines. Thus, the ranking of each of the advertisements has been multiplied by the weight of the vertical corresponding to of each of the advertisements. As such, advertisement 518 can have a score 602 of 0.3. The score of 602 is the product of ranking 524 times the weight 530, namely, 1 times 0.3. The score 604 for advertisement 502 is 0.25. The score 604 is the product of ranking 510 and weight 516, namely, 1 times 0.25. The score 606 for advertisement 520 is 0.225. The score 606 is the product of ranking 526 times the rate 530, namely 0.75 times 0.3. The score 608 for advertisement 504 can be 0.2. The score 608 corresponds to the product of ranking 512 times the weight 516, namely 0.8 times 0.25. The score 610 for advertisement 522 can be calculated as 0.18. The score 610 is the product of ranking 528 and weight 530, namely 0.6 times 0.3. Finally, the score 612 for advertisement 506 is 0.125. The score 612 is the product of ranking 514 times the weight of the first vertical 516, which is 0.5 times 0.25. As one skilled in the art will understand, this is only an example of a calculation of scores for multiple advertisements that originate from different vertical advertisement engines in order to be presented to a user. Once the scores have been calculated for all of the advertisements, the recommendation chooser engine 116 can further select the highest scores and present the corresponding advertisements to the network server 118 in order to display such advertisements to the user.

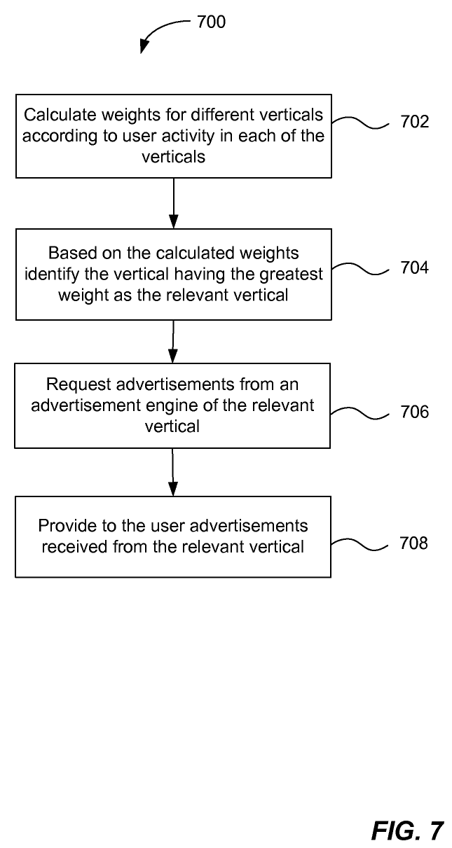

FIG. 7 depicts a flow diagram of a process for selecting advertisements relevant to the user according to another embodiment. At process block 702, the weights for different verticals are calculated according to user activity in each of the verticals. Process block 700 continues at process block 704.

At process block 704, a vertical from a group of verticals is selected such that the selected vertical has the greatest weight in comparison to the weight of all other verticals. As mentioned earlier, the weight assigned to each vertical is user-specific such that a vertical having a large weight in relation to one user may have a low weight in relation to another user. Once the vertical with the greatest weight is selected, such vertical can be identified as the relevant vertical. Process 700 continues at process block 706.

At process 706, advertisements are requested from the vertical advertisement engine corresponding to the relevant vertical. Thus, the recommendation chooser engine 116 can receive advertisements that are highly relevant to the user since the vertical from which the advertisements are derived is the vertical having the greatest weight for the user. Process 700 continues at process block 708.

At process block 708, the advertisements received from the vertical advertisement corresponding to the relevant vertical are presented to the user via the user computing device 102. As mentioned earlier, the network server 118 can be configured to transmit data to the user computing device 102, such that the data can be rendered at the user computing device 102. As such, the network server 118 can be configured to transmit relevant advertisements corresponding to the relevant vertical for presenting and displaying to the user.

In a further embodiment, multiple relevant verticals can be identified based on the weight of each of the verticals. For example, the verticals having the two highest weights can be utilized for providing advertisements to the user. In another example, the verticals having the three highest weights can be queries for advertisements to provide to the user.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of providing advertisements from multiple verticals, comprising:
calculating a first vertical weight for a first vertical according to user activity patterns of a user in the first vertical;
calculating a second vertical weight for a second vertical according to user activity patterns of the user in the second vertical;
receiving at least one first vertical advertisement from a first vertical advertisement engine;
receiving at least one second vertical advertisement from a second vertical advertisement engine;
calculating a first score for the at least one first vertical advertisement using the first vertical weight;
calculating a second score for the at least one second vertical advertisement using the second vertical weight;
providing the at least one first vertical advertisement to the user if the first score is higher than the second score; and
providing the at least one second vertical advertisement to the user if the second score is higher than the first score.

2. The method of claim 1, wherein user activity patterns of the user in the first vertical include searching the first vertical.

3. The method of claim 1, wherein user activity patterns of the user in the first vertical include selecting an item listed in the first vertical.

4. The method of claim 1, wherein user activity patterns of the user in the second vertical include searching the second vertical.

5. The method of claim 1, wherein user activity patterns of the user in the second vertical include selecting an item listed in the second vertical.

6. The method of claim 1, further comprising:
receiving a first associated rating for the at least one first vertical advertisement;
receiving a second associated rating for the at least one second vertical advertisement;
calculating the first score by multiplying the first vertical weight by the first associated rating; and
calculating the second score by multiplying the second vertical weight by the second associated rating.

7. The method of claim 1, wherein if the at least one first vertical advertisement has been provided to the user, further comprising providing the at least one second vertical advertisement to the user in order to provide at least two advertisements to the user.

8. The method of claim 1, wherein if the at least one first vertical advertisement has been provided to the user, further comprising providing the at least one second vertical advertisement to the user in order to provide at least two advertisements to the user.

9. The method of claim 1, further comprising:
calculating a third vertical weight for a third vertical according to user activity patterns of the user in the third vertical;
receiving at least one third vertical advertisement from a third vertical advertisement engine;
calculating a third score for the at least one third vertical advertisement using the third vertical weight; and
providing the at least one third vertical advertisement to the user if the third score is higher than the first score and the second score.

10. The method of claim 1, wherein the first vertical is an Internet job listing service, an Internet dating service, an Internet media delivery service, or an Internet media upload service.

11. The method of claim 1, wherein the second vertical is an Internet job listing service, an Internet dating service, an Internet media delivery service, or an Internet media upload service.

12. A system to provide advertisements from multiple verticals, comprising:
a recommendation chooser engine that calculates a first vertical weight for a first vertical according to user activity patterns of a user in the first vertical, and that calculates a second vertical weight for a second vertical according to user activity patterns of the user in the second vertical, the recommendation chooser engine further configured to calculate a first score for at least one first vertical advertisement using the first vertical weight, and to calculate a second score for at least one second vertical advertisement using the second vertical weight; and
a user interface module that provides the at least one first vertical advertisement to the user if the first score is higher than the second score, the user interface module further configured to provide the at least one second vertical advertisement to the user if the second score is higher than the first score.

13. The system of claim 12, further comprising:
a first vertical advertisement engine that transmits at least one first vertical advertisement to the recommendation chooser engine; and
a second vertical advertisement engine that transmits at least one second vertical advertisement to the recommendation chooser engine.

14. The system of claim 12, wherein user activity patterns of the user in the first vertical include user searching activity the first vertical.

15. The system of claim 12, wherein user activity patterns of the user in the first vertical include selected items listed in the first vertical.

16. The system of claim 12, wherein user activity patterns of the user in the second vertical include user searching activity in the second vertical.

17. The system of claim 12, wherein user activity patterns of the user in the second vertical include selected items listed in the second vertical.

18. The system of claim 12, wherein the recommendation chooser is further configured to receive a first associated rating for the at least one first vertical advertisement, and to receive a second associated rating for the at least one second vertical advertisement, the first score being calculated by multiplying the first vertical weight by the first associated rating, and the second score being calculated by multiplying the second vertical weight by the second associated rating.

19. The system of claim 12, wherein the recommendation chooser if further configured to calculate a third vertical weight for a third vertical according to user activity patterns of the user in the third vertical, at least one third vertical advertisement being received by the recommendation chooser from a third vertical advertisement engine, the recommendation chooser be further configured to calculate a third score for the at least one third vertical advertisement using the third vertical weight, the user interface module further configured to provide the at least one third vertical advertisement to the user if the first score is higher than the first score and the second score.

20. The system of claim 12, wherein the first vertical is an Internet job listing service, an Internet dating service, an Internet media delivery service, or an Internet media upload service.

21. The system of claim 12, wherein the second vertical is an Internet job listing service, an Internet dating service, an Internet media delivery service, or an Internet media upload service.

22. A method of providing advertisements from multiple verticals, comprising:
calculating a first vertical weight for a first vertical according to user activity patterns of a user in the first vertical;
calculating a second vertical weight for a second vertical according to user activity patterns of the user in the second vertical;
identifying a relevant vertical, wherein the relevant vertical is the first vertical if the first vertical weight is greater than the second vertical weight, wherein the relevant vertical is the second vertical if the second vertical weight is greater than the first vertical weight;
requesting at least one advertisement from a vertical advertisement engine corresponding to the relevant vertical; and
providing the at least one advertisement to the user.

23. The method of claim 22, further comprising calculating a third vertical weight for a third vertical according to user activity patterns of the user in the third vertical, wherein the relevant vertical is the third vertical if the third vertical weight is greater than the first vertical weight and the second vertical weight.

24. The method of claim 22, wherein the first vertical is an Internet job listing service, an Internet dating service, an Internet media delivery service, or an Internet media upload service.

25. The method oc claim 22, wherein the second vertical is an Internet job listing service, an Internet dating service, an Internet media delivery service, or an Internet media upload service.
